(19) United States
(12) Patent Application Publication
(10) Pub. No.: US 2004/0230700 A1
(43) Pub. Date: Nov. 18, 2004

(54) Information transmission method and information transmission apparatus

(75) Inventor: Akira Oomori, Kanagawa (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/843,506

(22) Filed: May 12, 2004

(30) Foreign Application Priority Data
May 15, 2003 (JP) 2003-137600

(51) Int. Cl. G06F 15/173; G06F 15/16

(52) U.S. Cl. 709/247; 709/238

(57) ABSTRACT

When a conversion destination format is a PDF format, and a transmission mode is an FTP mode, an image format is converted to the PDF format to calculate the converted image data size (S405). When the transmission mode is an email mode, the image format is converted to the PDF format, and further converted to a MIME ENCODE format to calculate the converted image data size (S407). When the conversion destination format is a TIFF-MMR format, and the transmission mode is the FTP mode, the image format is converted to the TIFF-MMR format to calculate the converted image data size (S409). When the transmission mode is the email mode, the image format is converted to the TIFF-MMR format, and further converted to the MIME ENCODE format to calculate the converted image data size (S411). The calculated size is then displayed (S412).

### FIELD OF THE INVENTION

The present invention relates to a technique of transmitting data read from a recording medium to a designated transmission destination.

### BACKGROUND OF THE INVENTION

In an apparatus which reads information such as an image and text recorded on a recording medium such as paper, and transmits the information to an external unit, a function of selecting a plurality of transmission protocols to transmit the information, and a function of selecting a transmission image file format and a transmission image compression format to transmit the information have been put into practical use. In such conventional reading/transmission apparatus, when a user wants to check a data size, the user can check the data size which is read from the recording medium and held in the apparatus. Thus, the technique of detecting the data size of the read image has been conventionally disclosed (e.g., see Japanese Patent Application No. 11-184767).

However, when the user actually transmits the data, the data size which is read and held in the file format and compression format designated in the transmission by the user is different from the image data size in reading. Hence, the user cannot know the data size to be actually transmitted.

Furthermore, since the user cannot know the data size even when the user does not want to transmit the data with an extremely large transmission data size, the user cannot determine whether the data is to be transmitted.

Furthermore, the reading/transmission apparatus cannot control to read the data in accordance with the transmission data size.

### SUMMARY OF THE INVENTION

The present invention has been made in consideration of the above problems, and has as its object to provide a technique of obtaining a transmission data size when a data format is converted to transmit the data in accordance with the format and a transmission mode designated by a user.

In order to achieve the above object, for example, an information transmission method of the present invention comprises the following arrangement.

That is, an information transmission method of transmitting data read from a recording medium to a designated transmission destination, comprising: a conversion format input step of inputting a conversion format in a case where a format of the data to be transmitted is converted, a transmission mode input step of inputting a transmission mode of the data, a conversion step of converting the data into a format corresponding to the transmission mode input in the transmission mode input step according to the conversion format input in the conversion format input step, a size calculation step of calculating size of a data size after being converted in the conversion step, a presenting step of presenting the size calculated in the size calculation step to the user, and a transmission step of transmitting the data to the transmission destination after being converted in the conversion step when a transmission instruction is input.

In order to achieve the above object, for example, an information transmission apparatus of the present invention comprises the following arrangement.

That is, an information transmission apparatus for transmitting data read from a recording medium to a designated transmission destination, comprising conversion format input unit, arranged to input a conversion format in a case where a format of the data to be transmitted is converted, transmission mode input unit, arranged to input a transmission mode of the data, conversion unit, arranged to convert the data into a format corresponding to the transmission mode input by the transmission mode input unit according to the conversion destination format input by the conversion format input unit, size calculation unit, arranged to calculate a data size after being converted by the conversion unit, presenting unit, arranged to present the size calculated by the size calculation unit to the user, and transmission unit, arranged to the data to the transmission destination after being converted by the conversion unit when a transmission instruction is input.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 shows a basic arrangement of an image reading/transmission apparatus according to the first embodiment of the present invention;

FIG. 2 shows an example of a window displayed on a display device 103;

FIG. 3A shows a format conversion of an image (obtained by scanning) in selecting a TIFF-MMR format;

FIG. 3B shows a format conversion of an image (obtained by scanning) in selecting a PDF format;

FIG. 4 is a flowchart showing processes of scanning the image, performing the conversion process, and transmitting the data executed by the image reading/transmission apparatus 1 according to the first embodiment of the present invention;

FIG. 5 is a flowchart showing processes of scanning the image, performing the conversion process, and transmitting the data executed by the image reading/transmission apparatus 1 according to the second embodiment of the present invention; and

FIG. 6 shows an example of the window displayed on the display window of the display device 103 in step S412.

### DETAILED DESCRIPTION OF THE PREFERRED EMBODIMENTS

Preferred embodiments of the present invention will now be described in detail in accordance with the accompanying drawings.

### First Embodiment

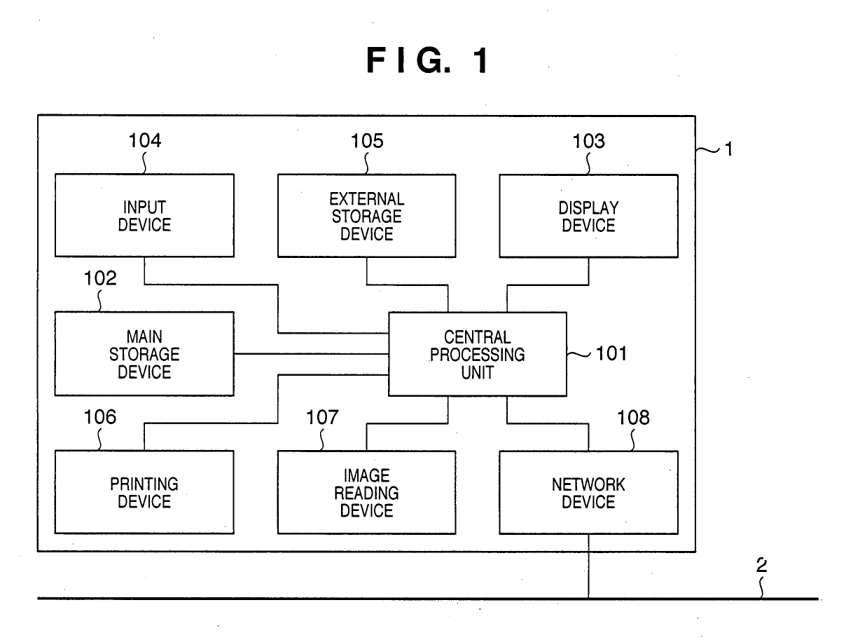

FIG. 1 shows a basic arrangement of an image reading/transmission apparatus according to this embodiment. Note that in the following description, a target to be read and transmitted is described as an “image”. The term “image” also includes text information. More specifically, even when the information containing the image and text is read, this information is held in the image reading/transmission apparatus, and transmitted as an image.

Referring back to FIG. 1, the image reading/transmission apparatus 1 according to this embodiment includes a central processing unit (to be referred as CPU hereinafter) 101, main storage device 102, display device 103, input device 104, external storage device 105, printing device 106, image reading device 107, and network device 108. These components will be described below.

The CPU 101 controls the above components which constitute the image reading/transmission apparatus 1 by using a program loaded from the external storage device 105 to the main storage device 102. The CPU 101 also performs various processes to be described below.

The main storage device 102 includes an area which temporally holds the program and data loaded from the external storage device 105, and also includes a work area that the CPU 101 uses for the various processes.

The display device 103 displays various kinds of information such as the image and text. The display device 103 is a touch-panel display device in this embodiment. Specifically, buttons and the like displayed on the display window of the display device 103 can be directly pointed with a finger or the like.

The input device 104 allow the user to input various instructions to the CPU 101, for example, the input device 104, which includes a group of buttons.

The external storage device 105 is a large capacity information storage device such as a hard disk. The external storage device 105 stores an OS (operating system) which controls the overall image reading/transmission apparatus 1, and the program and data for making the CPU 101 execute the various processes such as a format conversion process and data size calculation process to be described below. The external storage device 105 can also store image data read by the subsequent image reading device 107.

The printing device 106 forms an image on a recording medium such as paper or an OHP in accordance with the image data stored in the main storage device 102. The image reading device 107 reads (scans) the various kinds of information (image and text) recorded on the recording medium such as the paper and OHP, and outputs the read data to the main storage device 102 or external storage device 105.

The network device 108 includes a group of network interfaces in response to various networks to function as an interface for transmitting the data to other devices via a network 2. Note that in this embodiment, the image data read by the image reading device 107 is transmitted to other devices via the network device 108 and network 2 in an email mode or an FTP mode. Hence, the network device 108 functions in correspondence with this transmission. This network 2 also includes Ethernet®, a USB, serial connections, and parallel connections.

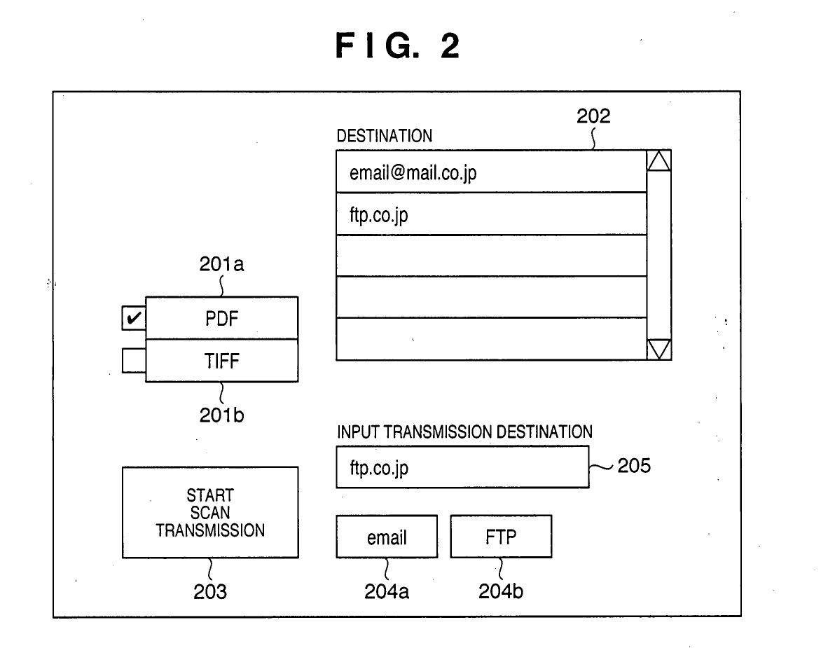

FIG. 2 shows an example of the window displayed on the display device 103. In FIG. 2, each of reference numerals 201a and 201b denotes a format selection button which selects and inputs a conversion destination format when the image data format is converted for transmitting the image data read by the image reading device 107 to the external device via the network 2. The button 201a is a button for inputting the instruction to set the conversion destination format to a PDF format. The button 201b is a button for inputting the instruction to set the conversion destination format to a TIFF-MMR format.

As described above, since the display device 103 is a touch-panel display device, each button portion can be pointed. It is obvious that the image portions of the buttons 201a and 201b can be also pointed. Hence, in order to set the conversion destination format to the PDF format, the user may point the image portion of the button 201a with a finger or the like as described above. As a result, a check mark is displayed near the image portion of the button 201a. On the other hand, in order to set the conversion destination format to the TIFF-MMR format, the user may point the image portion of the button 201b with a finger or the like as described above. As a result, a check mark is displayed near the image portion of the button 201b. In FIG. 2, as the check mark is displayed near the image portion of the button 201a, the PDF format has been selected.

Reference numeral 202 denotes an area in which the character string input in the area 205 is additionally displayed, when a character string (character string indicating the address of a transmission destination) is input in an area 205, and the user determines a transmission mode (email or FTP mode) by pointing one of the buttons 204a and 204b to be further described below. More specifically, when the transmission destination and the transmission mode are determined, the determined transmission destination is additionally displayed in this area.

Reference numeral 203 denotes a button for instructing the image reading device 107 to start scanning, and for instructing the network device 108 to transmit the scanned image to each of the transmission destinations displayed in the area 202. The user points the image portion of the button 203 with a finger or the like, so that the CPU 101 controls the image reading device 107 and network device 108, the image reading device 107 starts scanning, and the network device 108 performs a process to transmit the format-converted image (to be described below) to each of the transmission destinations displayed in the area 202 after the transmission instruction is input.

Reference numerals 204a and 204b denote buttons for inputting the transmission mode of the transmission image data. The button 204a is a button for inputting an instruction to set the transmission mode to an email mode. The button 204b is a button for inputting an instruction to set the transmission mode to an FTP mode.

Reference numeral 205 denotes an area in which a character string indicating the transmission destination is displayed when the transmission destination of the image obtained by scanning is input by using the input device 104.

Using the window shown in FIG. 2, the user can select and input the conversion destination format, transmission destination, and transmission mode, instruct to start scanning, and input the transmission instruction. However, the transmission image format varies in accordance with the conversion destination format and transmission mode.

The process of converting the image format obtained by scanning in accordance with the conversion destination format input by the button 201a or 201b, and the transmission mode input by the button 204a or 204b will be described below.

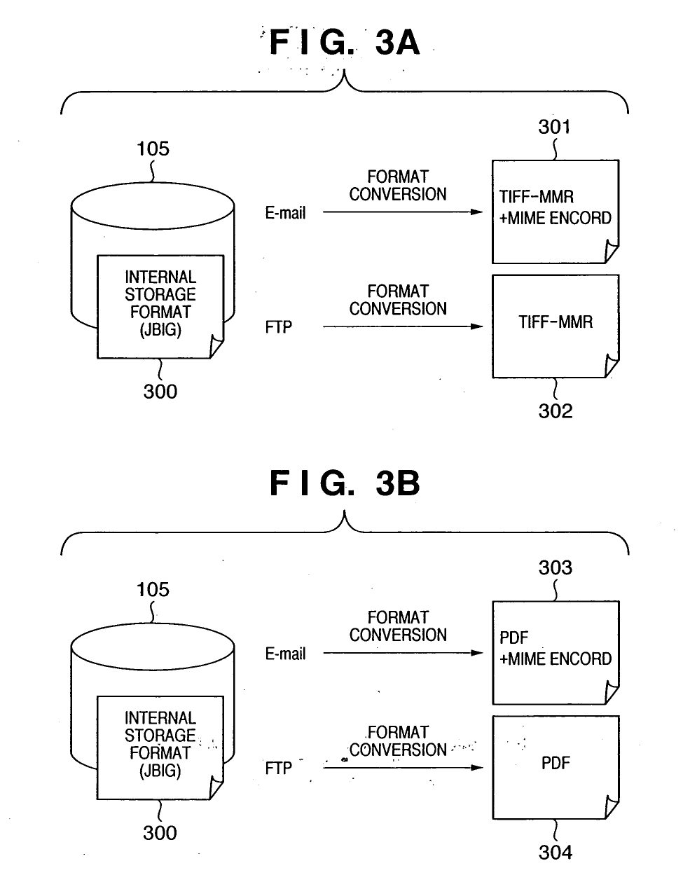

FIGS. 3A and 3B show a format conversion of an image (obtained by scanning) in selecting a TIFF-MMR format and a PDF format, respectively. The format (internal storage format) of an image 300 obtained by scanning is a JBIG format. This image 300 is stored in the external storage device 105.

Note that when the memory capacity of the main storage device 102 is sufficiently large, this image 300 may be stored in the main storage device 102.

In the window shown in FIG. 2, when the image portion of the button 201b is pointed, the instruction to set the conversion destination format to the TIFF-MMR format is input as described above. The transmission mode is then input by pointing one of the buttons 204a and 204b. When the button 204a is pointed, i.e., when the transmission mode is set to the email mode, the format of the image 300 is converted from the JBIG format to the TIFF-MMR format as shown in FIG. 3A. Furthermore, a MIME ENCODE process is performed in accordance with the email protocol. As a result, an image data 301 can be obtained by converting the format and mode to transmit the image 300 in the TIFF-MMR format and email mode.

On the other hand, when the button 204b is pointed, i.e., when the transmission mode is set to the FTP mode, the format of the image 300 is converted from the JBIG format to the TIFF-MMR format as shown in FIG. 3A. As a result, an image data 302 can be obtained by converting the format and mode to transmit the image 300 in the TIFF-MMR format and FTP mode.

Furthermore, on the window shown in FIG. 2, when the image portion of the button 201a is pointed, the instruction to set the conversion destination format to the PDF format is input. Next, the transmission mode is input by pointing any one of the buttons 204a and 204b. When the button 204a is pointed, i.e., when the transmission mode is set to the email mode, the format of the image 300 is converted from the JBIG format to the PDF format as shown in FIG. 3B, and a MIME ENCODE process is performed in accordance with the email protocol. As a result, an image data 303 can be obtained by converting the format and mode to transmit the image 300 in the PDF format and email mode.

On the other hand, when the button 204b is pointed, i.e., when the transmission mode is set to the FTP mode, the format of the image 300 is converted from the JBIG format to the PDF format as shown in FIG. 3B. As a result, an image data 304 can be obtained by converting the format and mode to transmit the image 300 in the PDF format and FTP mode.

As described above, the format of the image obtained by scanning can be converted to the format in accordance with the selected conversion destination format and the selected transmission mode.

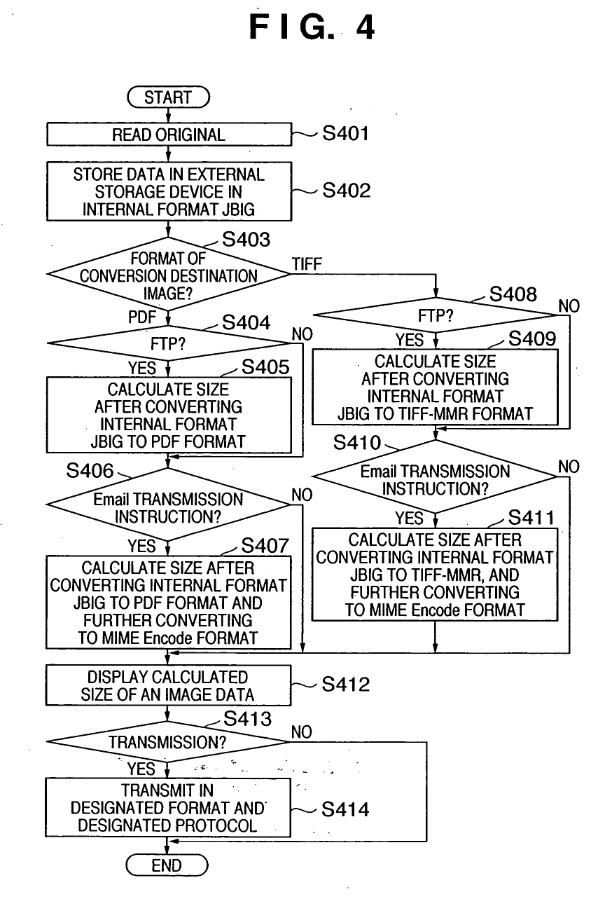

FIG. 4 is a flowchart showing processes of scanning the image, performing the conversion process, and transmitting the data executed by the image reading/transmission apparatus 1 according to this embodiment. A program according to the flowchart in FIG. 4 is stored in the external storage device 105, and loaded into the main storage device 102 as needed. Since the CPU 101 executes these processes, the image reading/transmission apparatus 1 according to this embodiment can perform the above processes.

In the first half process according to the flowchart in FIG. 4, the conversion destination format, transmission destination, and transmission mode have been input in the window shown in FIG. 2 (data indicating each of the input conversion destination format, transmission destination, and transmission mode has been stored in the main storage device 102 as setting data). Hence, the process (to be described below) is executed when the image portion of the scan transmission start button 203 is pointed on the window shown in FIG. 2.

In the flowchart in FIG. 4, the recording medium is an original. However, any other recording medium can be applied to the process according to the flowchart shown in FIG. 4.

Upon sensing that the button 203 is pointed, the CPU 101 controls the image reading device 107, and the image reading device 107 reads the information recorded on the storage medium such as paper as an image (step S401). The read image data is converted to the JBIG format, and stored in the external storage device 105 (step S402).

Next, the CPU 101 checks, with reference to the above setting data, which button is selected to be pointed from buttons 201a and 201b, i.e., which conversion destination format is selected to be input from the PDF format and TIFF-MMR format (step S403).

When the conversion destination format is input as the PDF format, the flow advances to step S404. The CPU checks whether the button 204b is pointed, i.e., whether the transmission mode is input as the FTP mode with reference to the above setting data (step S404).

When the CPU 101 determines that the button 204b is pointed, the flow advances to step S405. The format of “read image” stored in the external storage device 105 is converted from the JBIG format to the PDF format, the converted image data is obtained, and the size of the obtained image data is calculated (step S405). The converted image data is stored in the external storage device 105 again.

Next, the CPU 101 checks, with reference to the above setting data, whether the button 204a is pointed, i.e., whether the transmission mode is input as the email mode (step S406). When the CPU 101 determines that the button 204a is pointed, the flow advances to step S407. The format of the read image stored in the external storage device 105 is converted from the JBIG format to the PDF format, the image data format converted to the PDF format is further converted to a MIME ENCODE format, the converted image data is obtained, and the size of the obtained image data is calculated (step S407). The converted image data is stored in the external storage device 105 again.

By checking in step S403, when the conversion destination format is input as the TIFF-MMR format, the flow advances to step S408. The CPU checks whether the button 204b is pointed, i.e., whether the transmission mode is input as the FTP mode with reference to the above setting data (step S408).

When the CPU 101 determines that the button 204b is pointed, the flow advances to step S409. The format of “read image” stored in the external storage device 105 is converted from the JBIG format to the TIFF-MMR format, the converted image data format is obtained, and the size of the obtained image data is calculated (step S409). The converted image data is stored in the external storage device 105 again.

Next, the CPU 101 checks, with reference to the above setting data, whether the button 204a is pointed, i.e., whether the transmission mode is input as the email mode (step S410). When the CPU 101 determines that the button 204a is pointed, the flow advances to step S411. The format of the “read image” stored in the external storage device 105 is converted from the JBIG format to the TIFF-MMR format, the image data format converted to the TIFF-MMR format is further converted to a MIME ENCODE format, the converted image data is obtained, and the size of the obtained image data is calculated (step S411). The converted image data is stored in the external storage device 105 again.

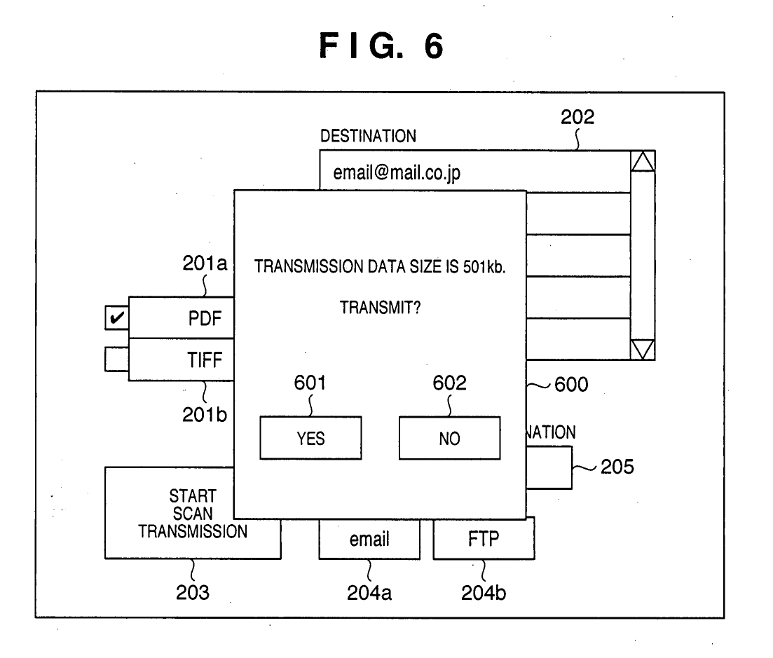

The calculated size is then displayed on the display window of the display device 103 (step S412). FIG. 6 shows a display example. In the window shown in FIG. 6, a new window 600 is displayed on the window shown in FIG. 2. This window 600 displays the calculated size, and a message and buttons 601 and 602 which prompt to determine whether the data converted to be transmitted by the above process is to be transmitted.

The object of the display of the window 600 is to present the display to the user, and to make the user determine whether the data of this size is to be transmitted. Hence, when the user comprehensively determines to transmit the data, the user instructs to transmit the data by directly pointing the image of the button 601 with the finger, pressing the predetermined button of the input device 104 (of course, this operation corresponds to the operation of pointing the button 601), or the like. Upon sensing the input of this transmission instruction (step S413), the CPU 101 controls the network device 108, and the network device 108 performs the process to transmit the image data to be transmitted which is obtained by the above process to the designated transmission destination (step S414).

On the other hand, when the user determines not to transmit the data, the user instructs to interrupt the process by directly pointing the image of the button 602 with the finger, pressing the predetermined button of the input device 104 (of course, this operation corresponds to the operation of pointing the button 602), or the like. Upon sensing the input of this transmission instruction (step S413), the CPU 101 ends the current process.

Note that the process according to the flowchart shown in FIG. 4 is performed when one transmission mode and one transmission destination format corresponding to one image are input. Therefore, as shown in FIG. 2, when a plurality of transmission destinations “email@mail.co.jp” and “ftp.co.jp” (the former is a transmission destination when the transmission mode is an email mode, and the latter is a transmission destination when the transmission mode is an FTP mode) corresponding to one image are set, the CPU 101 should perform the processes from steps S403 to S414 for the transmission destinations respectively, in the flowchart shown in FIG. 4.

As described above, the image reading/transmission apparatus 1 according to this embodiment can present the final transmission data size to the user by display. Hence, the user can check the final data size, and know an overload on the network before the transmission. As a result, the user can execute a next transmission setting with reference to the transmitted data size of the prior transmission setting (selecting of the conversion destination format and the like).

Note that the transmission image data size is provided to the user by display. However, the image data size can be also provided by the other means, e.g., speech. In this case, a speech output device including a D/A converter and loudspeaker is connected to the image reading/transmission apparatus 1, and the program for a speech synthesis process on the basis of text information is saved in the external storage device 105. The calculated size is then used as the text information to perform the speech synthesis, and the calculated size is output by speech.

In this embodiment, the format of the image data obtained by scanning is the JBIG format. However, the present invention is not limited to this.

In this embodiment, the transmission mode is selected from the email mode and FTP mode. However, the transmission mode may be selected from the two or more transmission modes, and the kinds of the transmission modes are not limited to these.

In this embodiment, the conversion destination format is selected from the PDF format and TIFF-MMR format. However, the conversion destination format may be selected from the three or more conversion destination formats, and the kinds of the conversion destination formats are not limited to these.

In this embodiment, the scanned image data is directly format converted and transmitted. However, an image which is scanned in advance may be stored in the external storage device 105, the image to be transmitted may be selected on the display window of the display device 103, and the selected image may be processed as described above.

The image reading/transmission apparatus 1 according to this embodiment obtains the image data by scanning information recorded on the recording medium. However, for example, a storage medium drive device for reading information recorded in the storage medium such as a CD-ROM and DVD-ROM may be connected to the image reading/transmission apparatus 1. The image data recorded in the CD-ROM, DVD-ROM, and the like may be read by the storage medium drive device, and output to the external storage device 105. As a result, the image data may be supplied to the image reading/transmission apparatus 1.

### Second Embodiment

In the first embodiment, data of one image is transmitted to one or a plurality of transmission destinations. However, in the second embodiment, recorded information of a plurality of pages is scanned from recording media including the plurality of pages as images, and the scanned plurality of images are transmitted.

Note that since the basic arrangement of an image reading/transmission apparatus 1, an example of a window displayed on a display device 103, and the format conversion of an image (image obtained by scanning) in selecting a TIFF-MMR format or PDF format according to this embodiment are the same as those of the first embodiment (respectively shown in FIGS. 1, 2, 3A, and 3B), a description thereof will be omitted.

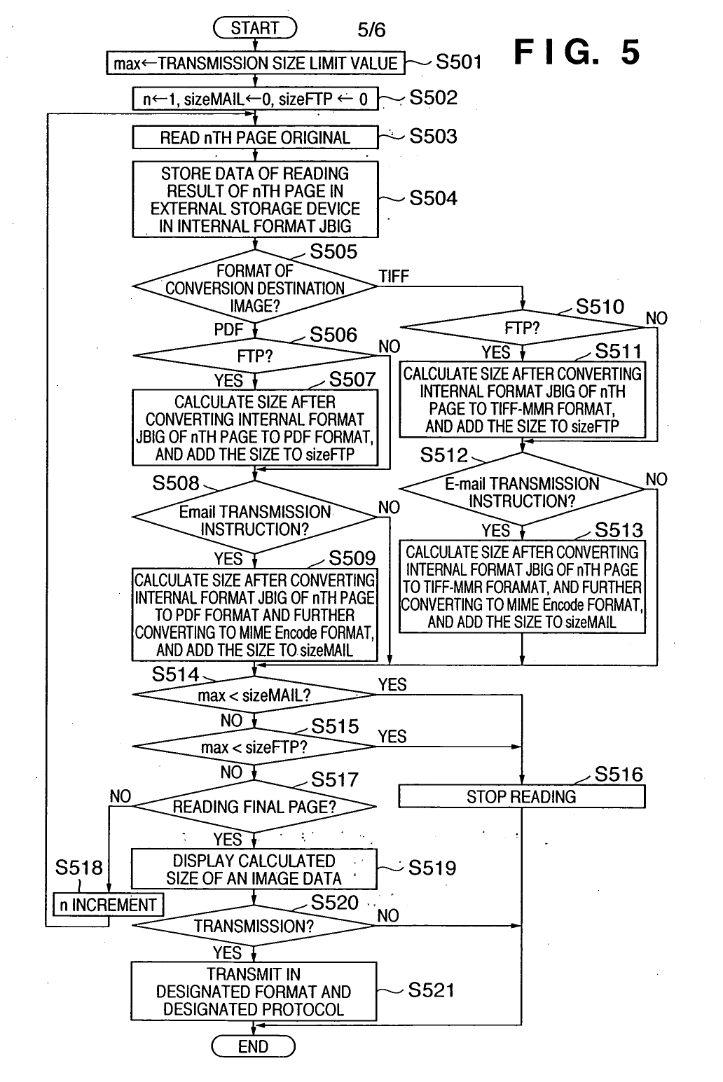

FIG. 5 is a flowchart showing processes of scanning the plurality of images, performing the conversion process, and transmitting the data executed by the image reading/transmission apparatus 1 according to this embodiment. A program according to the flowchart in FIG. 5 is stored in an external storage device 105, and loaded into a main storage device 102 as needed. Since a CPU 101 executes these processes, the image reading/transmission apparatus 1 according to this embodiment can perform the above processes.

In the first half process according to the flowchart in FIG. 5, the conversion destination format, transmission destination, and transmission mode have been input in the window shown in FIG. 2 (data indicating each of the input conversion destination format, transmission destination, and transmission mode has been stored in the main storage device 102 as setting data). Hence, the process (to be described below) is executed when the image portion of a scan transmission start button 203 is pointed on the window shown in FIG. 2.

In the flowchart in FIG. 5, the recording medium is an original. However, any other recording medium can be applied to the process according to the flowchart shown in FIG. 5.

First, the upper limit value of a transmittable data size is substituted for a variable max (step S501). This upper limit value may be manually input using an input device 104, or set in advance in the first half process of FIG. 5.

Next, 1 is substituted for a variable n, and 0 is substituted for each of a variable sizeMAIL and variable sizeFTP, thereby initializing these variables (S502).

When the above process is completed, the CPU 101 controls an image reading device 107, and the image reading device 107 reads the information recorded on the recording medium of nth page as an image (step S503). The read image data is converted to the JBIG format, and stored in the external storage device 105 (step S504).

Next, the CPU 101 checks, with reference to the above setting data, which button is selected to be pointed from buttons 201a and 201b, i.e., which conversion destination format is selected to be input from the PDF format and TIFF-MMR format (step S505).

When the conversion destination format is input as the PDF format, the flow advances to step S506. The CPU checks whether a button 204b is pointed, i.e., whether the transmission mode is input as the FTP mode with reference to the above setting data (step S506).

When the CPU 101 determines that the button 204b is pointed, the flow advances to step S507. The format of “read image” stored in the external storage device 105 is converted from the JBIG format to the PDF format, the converted image data is obtained, the size of the obtained image data is calculated, the calculated size is added to the value indicated by the variable sizeFTP, and the value is substituted for the variable sizeFTP again (step S507). The converted image data is stored in the external storage device 105 again.

Next, the CPU 101 checks, with reference to the above setting data, whether a button 204a is pointed, i.e., whether the transmission mode is input as the email mode (step S508). When the CPU 101 determines that the button 204a is pointed, the flow advances to step S509. The format of the “read image” stored in the external storage device 105 is converted from the JBIG format to the PDF format, the image data format converted to the PDF format is further converted to a MIME ENCODE format, the converted image data is obtained, and the size of the obtained image data is calculated, the calculated size is added to a value indicated by the variable sizeMAIL, and the value is substituted for the variable sizeMAIL again (step S509). The converted image data is stored in the external storage device 105 again.

By checking in step S505, when the conversion destination format is input as the TIFF-MMR format, the flow advances to step S510. The CPU checks whether the button 204b is pointed, i.e., whether the transmission mode is input as the FTP mode with reference to the above-described setting data (step S510).

When the CPU 101 determines that the button 204b is pointed, the flow advances to step S511. The format of “read image” stored in the external storage device 105 is converted from the JBIG format to the TIFF-MMR format, the converted image data is obtained, and the size of the obtained image data is calculated, the calculated size is added to a value indicated by the variable sizeFTP, and the value is substituted for the variable sizeFTP again (step S511). The converted image data is stored in the external storage device 105 again.

Next, the CPU 101 checks, with reference to the above setting data, whether the button 204a is pointed, i.e., whether the transmission mode is input as the email mode (step S512). When the CPU 101 determines that the button 204a is pointed, the flow advances to step S513. The format of the “read image” stored in the external storage device 105 is converted from the JBIG format to the TIFF-MMR format, the image data format converted to the TIFF-MMR format is further converted to a MIME ENCODE format, the converted image data is obtained, the size of the obtained image data is calculated, the calculated size is added to a value indicated by the variable sizeMAIL, and the value is substituted for the variable sizeMAIL again (step S513). The converted image data is stored in the external storage device 105 again.

The CPU 101 determines whether the value indicated by the variable sizeMAIL is equal to or more than a value indicated by the variable max (step S514). If max<sizeMAIL, the flow advances to step S515, and the CPU 101 determines whether the value indicated by the variable sizeFTP is equal to or more than the value indicated by the variable max (step S515). If max<sizeFTP, the flow advances to step S517.

If max≧sizeMAIL in step S514, or max≧sizeFTP in step S515, the flow advances to step S516. The CPU 101 controls the image reading device 107, and the image reading device 107 stops reading the image. That is, when the image data size converted in response to each of the conversion destination format and transmission mode is equal to or more than the transmittable upper limit value (value indicated by the variation max), the CPU 101 stops reading the image.

On the other hand, in step S517, the CPU 101 determines whether a next page to be read exists (step S517). If YES in step S517, one is added to the variable n, and the process from step S503 is performed for the next page.

If no in step S517, i.e., if all pages are processed as described above, the flow advances to step S519. The calculated size (the value indicated by the variable sizeMAIL when the button 204a is pointed, i.e., when the transmission mode is an email mode, or the value indicated by the variable sizeFTP when the button 204b is pointed, i.e., when the transmission mode is an FTP mode) is displayed on the display window of the display device 103 (step S519). In this case, the arrangement of the display window is the same as that in FIG. 6.

The object of the display of the window 600 is to present the display to the user, and to make the user determine whether the data of this size is to be transmitted. Hence, when the user comprehensively determines to transmit the data, the user instructs to transmit the data by directly pointing the image of the button 601 with the finger, pressing the predetermined button of the input device 104 (of course, this operation corresponds to the operation of pointing the button 601), or the like. Upon sensing the input of this transmission instruction (step S520), the CPU 101 controls the network device 108, and the network device 108 transmits all converted image data stored in the external storage device 105 to the designated transmission destination (step S521).

when the user determines not to transmit the data, the user instructs to interrupt the process by directly pointing the image of the button 602 with the finger, pressing the predetermined button of the input device 104 (of course, this operation corresponds to the operation of pointing the button 602), or the like. Upon sensing the input of this transmission instruction (step S520), the CPU ends the current process.

Note that the process according to the flowchart shown in FIG. 5 is performed when one transmission mode and one transmission destination format corresponding to one image are input. Therefore, as shown in FIG. 2, when a plurality of transmission destinations “email@mail.co.jp” and “ftp.co.jp” (the former is a transmission destination when the transmission mode is an email mode, and the latter is a transmission destination when the transmission mode is an FTP mode) corresponding to a plurality of images are set, the CPU 101 should perform the processes from steps S505 to S521 for the transmission destinations respectively, and the initialization process of the variable in step S502 when the data is transmitted to each of the transmission destinations in the flowchart shown in FIG. 5.

As described above, the image reading/transmission apparatus 1 according to this embodiment can present the size of the plurality of transmission images to the user by display. Hence, the user can check the final data size and know an overload on the network before the transmission. As a result, the user can execute a next transmission setting with reference to the transmitted data size of the prior transmission setting (selecting of the conversion destination format and the like).

In the image reading/transmission apparatus 1 according to this embodiment, the transmission data size is obtained. Hence, if the transmission data size is equal to or more than the predetermined size (the above-described transmittable upper limit value), the CPU controls the transmission process, e.g., not to transmit the data. Hence, the data can be transmitted in consideration of a load on the network by controlling this upper limit value. Additionally, the data can be transmitted in response to the memory capacity of the image reading/transmission apparatus 1.

Note that the transmission image data size is provided to the user by display. However, the image data size can be also provided by the other means, e.g., speech. In this case, a speech output device including a D/A converter and loudspeaker is connected to the image reading/transmission apparatus 1, and the program for a speech synthesis process on the basis of text information is saved in the external storage device 105. The calculated size is then used as the text information to perform the speech synthesis, and the calculated size is output by speech.

In this embodiment, the format of the image data obtained by scanning is the JBIG format. However, the present invention is not limited to this.

In this embodiment, the transmission mode is selected from the email mode and FTP mode. However, the transmission mode may be selected from the two or more transmission modes, and the kinds of the transmission modes are not limited to these.

In this embodiment, the conversion destination format is selected from the PDF format and TIFF-MMR formats. However, the conversion destination format may be selected from the three or more conversion destination formats, and the kinds of the conversion destination formats are not limited to these.

In this embodiment, the scanned image data is directly format converted to be transmitted. However, the plurality of images which are scanned in advance may be stored in the external storage device 105, the image to be transmitted may be selected on the display window of the display device 103, and the selected image may be processed as described above.

The image reading/transmission apparatus 1 according to this embodiment obtains the image data by scanning information recorded on the recording medium. However, for example, a storage medium drive device for reading information recorded in the storage medium such as a CD-ROM and DVD-ROM may be connected to the image reading/transmission apparatus 1. The image data recorded in the CD-ROM, DVD-ROM, and the like may be read by the storage medium drive device, and output to the external storage device 105. As a result, the image data may be supplied to the image reading/transmission apparatus 1.

### Other Embodiment

The present invention may be applied to a system constituted by a plurality of devices (e.g., a host computer, an interface device, a reader, a printer, and the like) or an apparatus comprising a single device (e.g., a copying machine, a facsimile apparatus, or the like).

The object of the present invention is achieved even by supplying a recording medium (or storage medium) which records software program codes for implementing the functions of the above-described embodiments to the system or apparatus and causing the computer (or a CPU or MPU) of the system or apparatus to read out and execute the program codes stored in the recording medium. In this case, the program codes read out from the recording medium implement the functions of the above-described embodiments by themselves, and the recording medium which records the program codes constitutes the present invention. The functions of the above-described embodiments are implemented not only when the readout program codes are executed by the computer but also when the operating system (OS) running on the computer performs part or all of actual processing on the basis of the instructions of the program codes.

The functions of the above-described embodiments are also implemented when the program codes read out from the storage medium are written in the memory of a function expansion board inserted into the computer or a function expansion unit connected to the computer, and the CPU of the function expansion board or function expansion unit performs part or all of actual processing on the basis of the instructions of the program codes.

When this embodiment is applied to the above recording medium, the recording medium stores the program code corresponds to the above-described flowchart and function arrangement.

As described above, in the present invention, a transmission data size can be obtained when a data format is connected to transmit the data in accordance with the format and a transmission mode designated by a user.

As many apparently widely different embodiments of the present invention can be made without departing from the spirit and scope thereof, it is to be understood that the invention is not limited to the specific embodiments thereof except as defined in the appended claims.

What is claimed is:

1. An information transmission method of transmitting data read from a recording medium to a designated transmission destination, comprising:
a conversion format input step of inputting a conversion format in a case where a format of the data to be transmitted is converted,
a transmission mode input step of inputting a transmission mode of the data,
a conversion step of converting the data into a format corresponding to the transmission mode input in the transmission mode input step according to the conversion format input in the conversion format input step,
a size calculation step of calculating size of a data size after being converted in the conversion step,
a presenting step of presenting the size calculated in the size calculation step to the user, and
a transmission step of transmitting the data to the transmission destination after being converted in the conversion step when a transmission instruction is input.

2. The method according to claim 1, wherein any one of a TIFF-MMR format and a PDF format is input in the conversion format input step.

3. The method according to claim 1, wherein, in the conversion step, the data read from the recording medium is converted into the TIFF-MMR format to further execute a MIME-ENCODE conversion process in a case where the conversion format is a TIFF-MMR format, and the transmission mode input in the transmission mode input step is an email mode, and
the data read from the recording medium is converted into the TIFF-MMR format when the transmission mode input in the transmission mode input step is an FTP mode.

4. The method according to claim 1, wherein, in the conversion step, the data read from the recording medium is converted into the PDF format to further execute a MIME-ENCODE conversion process in a case where the conversion format is a PDF format, and the transmission mode input in the transmission mode input step is an email mode, and
the data read from the recording medium is converted into the PDF format in a case where the transmission mode input in the transmission mode input step is an FTP mode.

5. The method according to claim 1, further comprising
a count step of counting the size calculated in the size calculation step for each page in case of reading information recorded on each of the pages from the recording media including a plurality of pages,
wherein reading data from the recording medium is interrupted when a count value counted in the count step is not less than the predetermined value.

6. An information transmission apparatus for transmitting data read from a recording medium to a designated transmission destination, by comprising
conversion format input unit, arranged to input a conversion format in a case where a format of the data to be transmitted is converted,
transmission mode input unit, arranged to input a transmission mode of the data,
conversion unit, arranged to convert the data into a format corresponding to the transmission mode input by said transmission mode input unit according to the conversion destination format input by said conversion format input unit,
size calculation unit, arranged to calculate a data size after being converted by said conversion unit,
presenting unit, arranged to present the size calculated by said size calculation unit to the user, and
transmission unit, arranged to the data to the transmission destination after being converted by said conversion unit when a transmission instruction is input.

7. A program for making a computer execute an information transmission method according to claim 1.

8. A computer-readable storage medium for storing a program according to claim 7.
